(19) United States
(12) Patent Application Publication
(10) Pub. No.: US 2026/0039951 A1
(43) Pub. Date: Feb. 5, 2026

(54) DEVICE MODULE, NETWORK DEVICE, AND VEHICLE

(71) Applicant: ROHM Co., Ltd., Kyoto (JP)

(72) Inventor: Yuichi Kokusho, Kyoto (JP)

(73) Assignee: ROHM Co., Ltd., Kyoto (JP)

(21) Appl. No.: 19/278,794

(22) Filed: Jul. 24, 2025

(30) Foreign Application Priority Data
Aug. 1, 2024 (JP) 2024-125621

(51) Int. Cl. H04N 23/66; B60R 16/023

(52) U.S. Cl. CPC H04N 23/66; B60R 16/0231

(57) ABSTRACT

A device module is provided, which includes a communication path, a semiconductor device, an interface connected to the communication path, and a second control unit. The second control unit, in a first state, generates a setting signal including setting information and inputs the setting signal to the semiconductor device.

### CROSS-REFERENCE TO RELATED APPLICATION

This application claims the priority benefit of Japanese application serial no. 2024-125621, filed on Aug. 1, 2024. The entirety of the above-mentioned patent application is hereby incorporated by reference herein and made a part of this specification.

### TECHNICAL FIELD

The disclosure in this specification relates to a device module, a network device, and a vehicle.

### Background Technology

Conventionally, there is a network device that includes multiple device modules such as in-vehicle equipment.

Patent Document 1 (Japanese Patent Application Laid-Open No. 2017-211864) can be mentioned as an example of conventional technology related to the above.

The device module disclosed in Patent Document 1 requires further consideration regarding the time required for various settings made through the network device.

### SUMMARY

A device module disclosed in this specification includes a communication path, a semiconductor device, an interface, and a second control unit. The semiconductor device is connected to the communication path and is configured to operate based on input setting information. The interface is connected to the communication path and is configured to establish communication between multiple targets connected to the communication path and a first control unit. The second control unit is connected to the communication path and is configured to operate in a first state of communicating with the semiconductor device with the second control unit as a controller and the semiconductor device as a target, or in a second state of communicating with the first control unit via the interface with the second control unit as a target and the first control unit as a controller. The second control unit, in the first state, generates a setting signal including setting information and inputs the setting signal to the semiconductor device.

A network device disclosed in this specification includes the device module having the above configuration, a first control unit, and a communication bus. The communication bus electrically connects the device module and the first control unit to establish communication between the device module and the first control unit via the interface.

A vehicle disclosed in this specification includes the network device having the above configuration.

### BRIEF DESCRIPTION OF THE DRAWINGS

FIG. 1 is a block diagram showing the configuration of the network device 100 of the disclosure.

FIG. 2 is a block diagram showing the internal configuration of the device module 2a.

FIG. 3 is a diagram showing the internal configuration of the device module 2a of the first embodiment according to the disclosure in more detail.

FIG. 4 is a diagram showing the internal configuration of the device module 2a of the first embodiment according to the disclosure in more detail.

FIG. 5 is a diagram showing the configuration of the device module 2a according to the second embodiment.

FIG. 6 is a block diagram showing the configuration of the vehicle 200 that includes the network device 100.

### DETAILED DESCRIPTION

### Basic Configuration

First, the basic configuration of a network device 100 of the disclosure will be described.

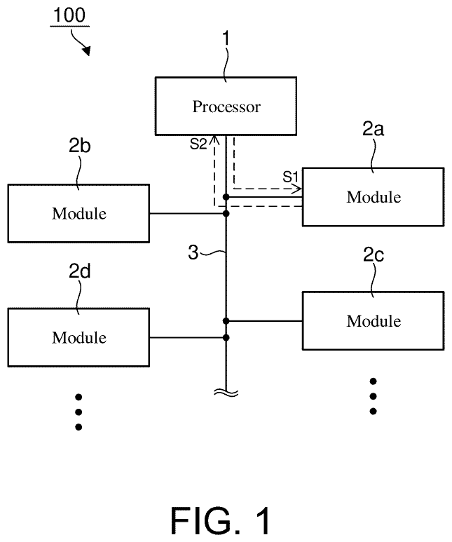

FIG. 1 is a block diagram showing the configuration of the network device 100 of the disclosure. The network device 100 includes a processor 1, multiple device modules (according to this figure, device modules 2a, 2b, 2c, and 2d), and a communication bus 3.

The processor 1 is an arithmetic circuit (for example, MPU [Micro Processing Unit], ECU [Electronic Control Unit], etc.) that comprehensively controls the network device 100. The processor 1 has an oscillator OSC1. The oscillator OSC1 generates a clock signal for communication performed between the processor 1 and the device modules 2a to 2d.

Here, the device modules 2a to 2d will be described as having a common configuration. Therefore, only the device module 2a will be described, and the description of the device modules 2b to 2d will be partially omitted.

The device module 2a is in-vehicle equipment mounted in a vehicle. Here, as an example, the device module 2a will be described using a configuration that the device module 2a is an in-vehicle camera module configured to include an image sensor (imager 5 which will be described later). The device module 2a generates an electrical signal based on light and dark images formed through a lens. The detailed configuration of the device module 2a will be described later.

The communication bus 3 is a communication path that electrically connects the processor 1 and each of the device modules 2a to 2d to enable communication. The communication bus 3 can be compliant with serial communication (for example, I2C [Inter-Integrated Circuit]) standards. In this case, the communication bus 3 becomes a two-wire system including an SDL line that transmits a clock signal and an SDA line that transmits a data signal (not shown). Although each signal described below is basically illustrated as indicating a data signal, it may be interpreted to include a clock signal.

In the normal state (=second state), the processor 1 becomes a controller, and each of the device modules 2a to 2d becomes a target, establishing communication via the communication bus 3. That is, in the normal state, a predetermined signal is input from the processor 1 to each of the device modules 2a to 2d, and in response to this signal, each of the device modules 2a to 2d inputs a predetermined signal to the processor 1. Specific details are as follows.

The processor 1 inputs a communication signal S1 to the device module 2a. Then, the device module 2a generates a communication signal S2 in response to the communication signal S1, and inputs the communication signal S2 to the processor 1. At this time, the processor 1 becomes a controller, and the device module 2a becomes a target. The communication signal S2 includes information (for example, information about light and dark images formed through a lens) corresponding to the communication signal S1.

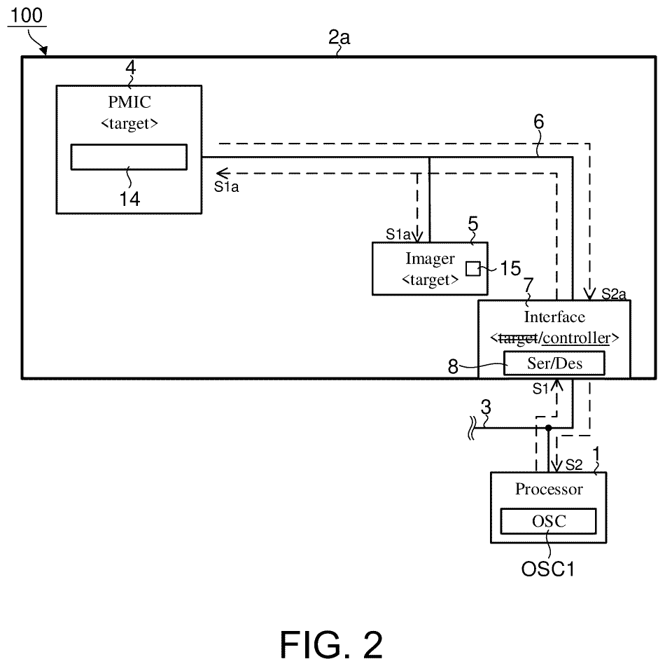

FIG. 2 is a block diagram showing the internal configuration of the device module 2a. The device module 2a includes a PMIC [Power Management IC] 4, an imager 5, a communication path 6, and an interface 7.

The PMIC 4 is a power control IC [integrated circuit] that controls the power supply of the device module 2a. Specifically, the PMIC 4 controls the driving power of each of the imager 5 and the interface 7.

The PMIC 4 includes an internal memory 14. The internal memory 14 is a temporary storage area such as a register. The PMIC 4 is capable of generating a signal to include information stored in the internal memory 14. When communicating with the imager 5 and the interface 7, the PMIC 4 temporarily stores information in the internal memory 14 as needed.

The imager 5 is a semiconductor device such as an image sensor including a CMOS sensor, a lens, etc. (not shown). The imager 5 is configured to acquire image information (=information about light and dark images formed through a lens).

The imager 5 includes an internal memory 15. The internal memory 15 is configured to be capable of storing predetermined information (for example, setting information If1, information of various states in the imager 5, environmental information, etc.). The setting information If1 is information for defining the operation of the imager 5 and includes a control value. The imager 5 operates based on the setting information If1 stored in the internal memory 15. Specific examples of the setting information If1 include exposure time, Gain, resolution (pixel addition, thinning number), frame rate, ROI [Region of Interest], various counter values, other operation modes, etc.

The communication path 6 is a communication path provided inside the device module 2a. The communication path 6 electrically connects the PMIC 4, the imager 5, and the interface 7 to each other. The communication path 6 complies with the serial communication (for example, I2C) standards.

The interface 7 is electrically connected to the communication path 6 inside the device module 2a. The interface 7 is electrically connected to the processor 1 via the communication bus 3 outside the device module 2a.

The interface 7 includes a Ser/Des [SERializer/DESerializer] circuit 8. The Ser/Des circuit 8 is capable of communicating with the PMIC and the imager 5 by serial communication. The Ser/Des circuit 8 is capable of communicating with the processor 1 and the device modules 2b to 2c by parallel communication.

The Ser/Des circuit 8 converts a parallel signal input from the communication bus 3 into a serial signal and inputs the serial signal to the PMIC 4 or the imager 5. The Ser/Des circuit 8 also converts a serial signal input from the PMIC 4 or the imager 5 into a parallel signal and inputs the parallel signal to the processor 1 or the device modules 2b to 2c via the communication bus 3.

### Regarding Basic Communication of Network Device 100

As described above, the processor 1 is capable of communicating with the device modules 2a to 2d via the communication bus 3. The internal configuration of the device module 2a and the processor 1 are capable of communicating via the interface 7. More specific details are as follows.

Each of the PMIC 4 and the imager 5 is capable of communicating with the processor 1 via the communication path 6 and the interface 7. In a case where the PMIC 4 and the processor 1 communicate, the interface 7 becomes a controller, and the PMIC 4 becomes a target to establish communication. That is, based on the clock signal generated by the oscillator OSC1, the PMIC 4 communicates with the processor 1. Specific details are as follows.

First, the processor 1 inputs a communication signal S1 to the interface 7 via the communication bus 3. Then, the interface 7 converts the input communication signal S1 into a communication signal S1a by the Ser/Des circuit 8. And, the interface 7 inputs the communication signal S1a to the PMIC 4 via the communication path 6. The communication signal S1 is a parallel signal, and the communication signal S1a is a serial signal.

Then, in response to the communication signal S1a, the PMIC 4 inputs a communication signal S2a to the interface 7 via the communication path 6. The interface 7 generates a communication signal S2 suitable for the communication bus 3 based on the communication signal S2a, and inputs the communication signal S2 to the processor 1 via the communication bus 3. In a case where the imager 5 communicates with the processor 1, the communication mode is similar to the communication mode between the PMIC 4 and the processor 1 as described above.

### Consideration on Setting of Imager

Next, the setting of the imager will be described, which is equivalent to the above-mentioned configuration of the network device 100 and adopts a conventional general configuration. In the case of adopting such a general configuration, a setting signal for setting the imager (corresponding to the imager 5) is output from a central processing circuit (corresponding to the processor 1). Then, this setting signal is input to each device module (corresponding to the device modules 2a to 2d described above). This setting signal is input to the imager via an interface (corresponding to the interface 7). Various settings are made in the imager based on this setting signal.

However, in the case of adopting such a configuration, the timing of communication between each of the device modules and the central processing circuit is configured to be separate from each other. Specifically, each device module is individually allocated a timing for communication with the central processing circuit so as not to overlap with the timings of other device modules. Therefore, at startup, each device module enters a standby state until the timing allocated thereto arrives. Consequently, in a case where all imagers of the device modules are set simultaneously (for example, in the case of performing the initial setting of the imagers), there is a risk that it may take a relatively long time for all the settings to be completed.

In response to such a problem, the device modules 2a to 2d of the disclosure are capable of suppressing the prolongation of time required for setting the imager 5. The following describes the device module 2a according to each embodiment of the network device 100 in more detail.

Regarding Detailed Configuration of Device Module of First Embodiment according to the Disclosure

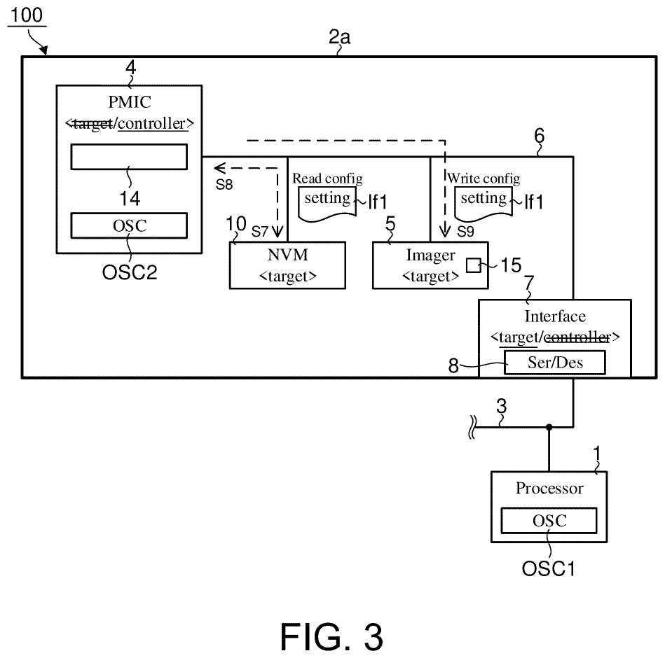

FIG. 3 is a diagram showing the internal configuration of the device module 2a of the first embodiment according to the disclosure in more detail. FIG. 3 shows a case where communication inside the device module 2a has been established with the PMIC 4 as a controller. As shown in FIG. 3, the device module 2a according to the first embodiment of the disclosure includes a non-volatile memory 10 in addition to the configuration described above.

The non-volatile memory 10 is a memory capable of storing various information in a non-volatile manner. Setting information If1 is stored in the non-volatile memory 10.

The non-volatile memory 10 is capable of communicating with each of the PMIC 4 and the interface 7 via the communication path 6. The non-volatile memory 10 is configured to output information stored therein (for example, setting information If1) in response to an instruction from each of the PMIC 4 and the interface 7.

The PMIC 4, at a predetermined timing (for example, when setting the imager 5 as described later), is capable of communicating with the non-volatile memory 10, the imager 5, and the interface 7 as targets, with the PMIC 4 itself as a controller. Also, the PMIC 4, at another timing (for example, during the normal state described above), is capable of communicating with the PMIC 4 itself as a target and the interface 7 as a controller. Details will be described as follows.

The PMIC 4 includes an oscillator OSC2 in addition to the configuration described above. The oscillator OSC2 generates a clock signal for communication, with the PMIC 4 as a controller and the non-volatile memory 10, the imager 5, or the interface 7 as a target.

The PMIC 4, during the state of setting the imager 5 (=first state), establishes communication with each of the non-volatile memory 10 and the imager 5, with the PMIC 4 as a controller. At this time, the PMIC 4 communicates with each of the non-volatile memory 10 and the imager 5 via the communication path 6 based on the clock signal generated by the oscillator OSC2.

At this time, first, the PMIC 4 reads the setting information If1 from the non-volatile memory 10. Specifically, the PMIC 4 inputs a communication signal S7 to the non-volatile memory 10 via the communication path 6. The non-volatile memory 10, in response to a communication signal S6, inputs a communication signal S8 to the PMIC 4 via the communication path 6. The communication signal S8 includes the setting information If1.

In response to receiving the communication signal S8, the PMIC 4 writes the setting information If1 included in the communication signal S8 to the internal memory 15 of the imager 5. More specific details are as follows. In response to receiving the communication signal S8, the PMIC 4 temporarily stores the setting information If1 included in the communication signal S8 in the internal memory 14. Then, the PMIC 4 generates a setting signal S9 to include the setting information If1 stored in the internal memory 14. Then, the PMIC 4 inputs the setting signal S9 to the imager 5 via the communication path 6. The communication signals S7, S8, and the setting signal S9 are serial signals.

In response to receiving the setting signal S9, the imager 5 stores the setting information If1 included in the setting signal S9 in the internal memory 15. This completes the setting of the imager 5. Thereafter, the imager 5 operates based on the setting information If1 stored in the internal memory 15. The setting of the imager 5 is performed, for example, at startup of the network device 100.

When writing the setting information If1 to the internal memory 15, the PMIC 4 may read all the bits constituting the setting information If1 and store the same in the internal memory 14, and then input the setting signal S9 including all the bits constituting the setting information If1 to the imager 5. In this case, the imager 5 stores the setting information If1 included in the setting signal S9 in the internal memory 15. This completes the setting of the imager 5 in a single timing.

Alternatively, the following may be applied. For example, the PMIC 4 first stores only a predetermined number of bits from all the bits constituting the setting information If1 in the internal memory 14. Then, the PMIC 4 temporarily terminates communication with the non-volatile memory 10. Next, the PMIC 4 inputs the setting signal S9 including the bits of the setting information If1 stored in the internal memory 14 to the imager 5. Then, the imager 5 stores the bits of the setting information If1 included in the setting signal S9 in the internal memory 15. Thereafter, the PMIC 4 reads the remaining bits of the setting information If1 from the non-volatile memory 10 at a predetermined timing and stores the same in the internal memory 14. Then, the PMIC 4 inputs the setting signal S9 including the remaining bits stored in the internal memory 14 to the imager 5. Then, the imager 5 stores the bits of the setting information If1 included in the setting signal S9 in the internal memory 15. The predetermined number of bits mentioned above is defined in byte unit. In addition, the number of bytes in this case is arbitrary.

Further, as described above, during the normal state (=second state), the PMIC 4 establishes communication with the interface 7, with the PMIC 4 itself as a target. At this time, the PMIC 4 communicates with the processor 1 via the communication bus 3 based on the clock signal generated by the oscillator OSC1 as described above. For example, during this normal state, the processor 1 is capable of reading information stored in the non-volatile memory 10.

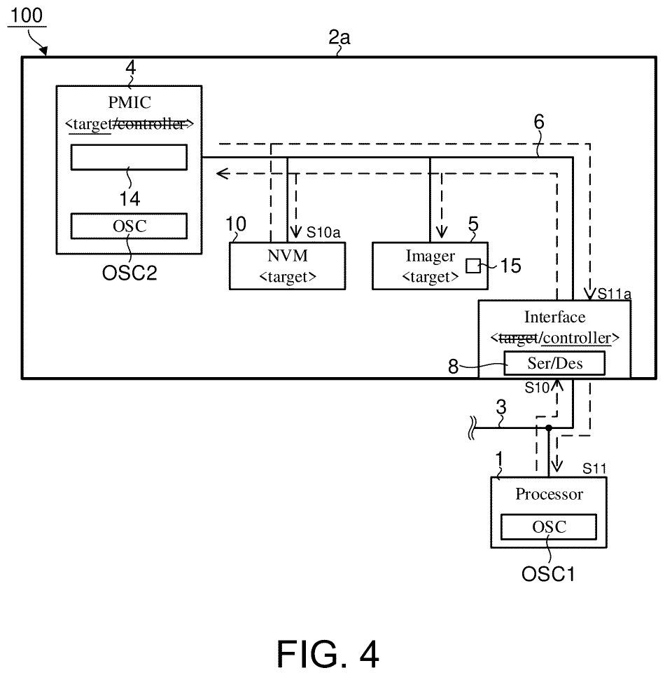

FIG. 4 is a diagram showing the internal configuration of the device module 2a of the first embodiment according to the disclosure in more detail. In this case (=the above-mentioned normal state (second state)), as shown in FIG. 4, the processor 1 side (more specifically, the interface 7) becomes a controller, and communication is established with the non-volatile memory 10 as a target.

First, the processor 1 inputs a communication signal S10 to the interface 7 via the communication bus 3. Then, the interface 7 generates a communication signal S10a suitable for the non-volatile memory 10 based on the communication signal S10. Then, the interface 7 inputs the communication signal S10a to the non-volatile memory 10 via the communication path 6.

The non-volatile memory 10, in response to the communication signal S10a, inputs the communication signal S11a to the interface 7 via the communication path 6. The interface 7 generates a communication signal S11 suitable for the communication bus 3 based on the communication signal S11a. Then, the interface 7 inputs the communication signal S11 to the processor 1 via the communication bus 3. The communication signals S10a and S11a at this time are serial signals. In addition, the communication signals S10 and S11 are parallel signals.

In this case, the PMIC 4 may read information from the non-volatile memory 10 and input a signal including this information to the processor 1 via the communication path 6, the interface 7, and the communication bus 3.

In this way, the PMIC 4 according to the disclosure is configured to be capable of communicating with each of the non-volatile memory 10, the imager 5, and the interface 7 (more specifically, the processor 1), with the PMIC 4 itself as a controller in the state (=first state) of setting the imager 5, and as a target in the normal state (=second state).

Similarly, the interface 7, in the state of setting the imager 5, either becomes a target itself or does not perform communication with the PMIC 4. Also, the interface 7, in the above-mentioned normal state, becomes a controller itself and is configured to be capable of communicating with each of the non-volatile memory 10 and the imager 5.

As described above, the setting of the imager 5 is made based on the setting signal S7 output from the PMIC 4 (refer to FIG. 3). That is, when setting the imager 5, communication between the device module 2a and the processor 1 becomes unnecessary. Accordingly, the setting of the imager 5 can be completed with processing within the device module 2a. Therefore, even in the case of simultaneously setting the imagers 5 of the device modules 2a to 2d, each of the device modules 2a to 2d can perform the setting of its own imager 5 without waiting for the communication timing with the processor 1. In this way, the device modules 2a to 2d of the disclosure can suppress the time required for setting the imager 5 from being prolonged.

Further, as described above, the communication path 6 is an existing communication path that electrically connects the PMIC 4, the non-volatile memory 10, the imager 5, and the interface 7 to enable mutual communication in the normal state. Therefore, there is no need to establish a new communication path between the PMIC 4 and the imager 5 for setting the imager 5. Accordingly, the device modules 2a to 2d of the disclosure can respectively suppress an increase in circuit area and an increase in manufacturing cost.

Regarding Detailed Configuration of Device Module of Second Embodiment according to the Disclosure

Next, the device module 2a of the second embodiment according to the disclosure will be described in detail. The device module 2a of this embodiment has a configuration in common with the device module 2a of the first embodiment described above. Therefore, the same reference numerals as those of the first embodiment are assigned for the common configuration and the description is omitted. The same applies to the device modules 2b to 2d.

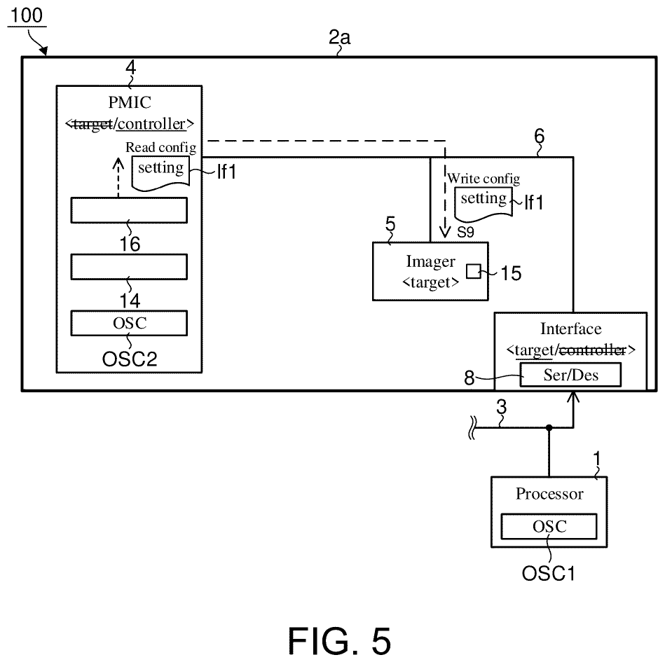

FIG. 5 is a diagram showing the configuration of the device module 2a according to the second embodiment in more detail. As shown in FIG. 5, the PMIC 4 according to this embodiment includes an internal memory 16 in addition to the internal memory 14. The internal memory 16 is a non-volatile memory (for example, OTP [One Time Programmable], MTP [Multiple Time Programmable], etc.). The internal memory 16 stores the setting information If1.

As shown in FIG. 5, in the state of setting the imager 5, communication is established with the PMIC 4 as a controller and the imager 5 as a target. In addition, in this state, the interface 7 can also be a target as needed.

The PMIC 4 according to this embodiment, when setting the imager 5, reads the setting information If1 from the internal memory 16 and writes the setting information If1 to the internal memory 15 of the imager 5. More specific details are as follows. First, the PMIC 4 reads the setting information If1 from the internal memory 16 and generates the setting signal S9. Then, the PMIC 4 inputs the setting signal S9 to the imager 5 via the communication path 6. The PMIC 4 simultaneously reads the setting information If1 from the internal memory 16, generates the setting signal S9 to include the sequentially read setting information If1, and inputs the setting signal S9 to the imager 5.

In response to receiving the setting signal S9, the imager 5 stores the setting information If1 included in the setting signal S9 in the internal memory 15. This completes the setting of the imager 5. Then, the imager 5 operates based on the setting information If1 stored in the internal memory 15.

As described above, the PMIC 4 of this embodiment includes the internal memory 16. And, the PMIC 4 is configured to read the setting information If1 from the internal memory 16 and write the setting information If1 to the imager 5. Therefore, it is no longer necessary to mount a non-volatile memory for storing the setting information If1 outside the PMIC 4. As a result, the circuit area of the device module 2a can be reduced.

Furthermore, as described above, the PMIC 4 of this embodiment inputs the setting signal S9 to the imager 5 simultaneously with reading the setting information If1. Therefore, the amount of information of the setting information If1 temporarily stored in the internal memory 14 can be made relatively small. Consequently, the capacity of the internal memory 14 can be made relatively small, making it possible to reduce the circuit area of the PMIC 4.

Regarding Vehicle 200 Equipped with Network Device 100

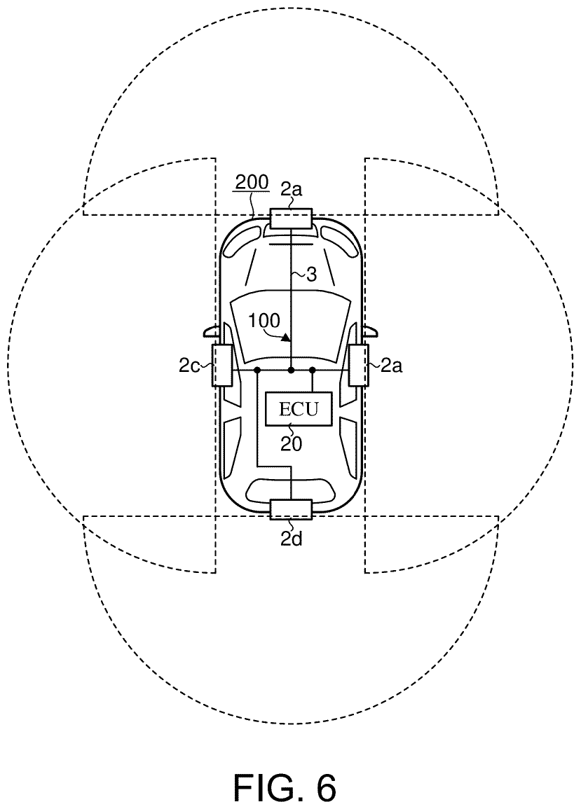

Next, a vehicle 200 equipped with the network device 100 described above will be described. FIG. 6 is a block diagram showing the configuration of the vehicle 200 that includes the network device 100. As shown in FIG. 6, the network device 100 can be mounted in the vehicle 200. The network device 100 includes an ECU 20, device modules 2a to 2d, and a communication bus 3. The ECU 20 corresponds to the processor 1 described above. The ECU 20 is electrically connected to the device modules 2a to 2d via the communication bus 3.

The device module 2a is disposed at the front of the vehicle 200. The device module 2a captures images of the front side. The device module 2b is disposed on the right side of the vehicle 200. The device module 2b captures images of the right side. The device module 2c is disposed on the left side of the vehicle 200. The device module 2c captures images of the left side. The device module 2d is disposed at the rear of the vehicle 200. The device module 2d captures images of the rear side.

Each of the device modules 2a to 2d converts the captured image into an imaging signal and outputs the imaging signal to the ECU 20. Thus, the ECU 20 can capture 360-degree (omnidirectional) images of the front, left, right, and rear of the vehicle 200.

### Modification Example

Furthermore, the disclosure is not limited to the above embodiments, and various changes are possible within the scope that does not deviate from the spirit of the disclosure. For example, in the above embodiments, the device modules 2b to 2d are described as being similar to the device module 2a, but the disclosure is not limited thereto. For example, each of the device modules 2b to 2d may be an in-vehicle camera module equivalent to the device module 2a, or may be a module of a device with other functions. In this case, the device modules 2b to 2d are capable of communicating with the processor 1 in a mode where the device modules 2b to 2d themselves are targets and the processor 1 is a controller, similar to the device module 2a described above.

In addition, the setting of the imager 5 using the setting signal S9 as described above can also be applied to settings other than the initial setting. For example, after startup of the network device 100, the setting signal S9 may be input from the PMIC 4 to the imager 5 as described above to change the setting of the imager 5 even when changing the setting of the imager 5 at a predetermined timing.

### Appendix

A device module (2a to 2d) disclosed in the specification is configured to include: a communication path (6); a semiconductor device (5) connected to the communication path (6) and configured to operate based on setting information (If1); an interface (7) connected to the communication path (6) and configured to establish communication between a plurality of targets connected to the communication path (6) and a first control unit (1); and a second control unit (4) connected to the communication path (6) and configured to operate in a first state of communicating with the semiconductor device (5) with the second control unit as a controller and the semiconductor device (5) as a target, or in a second state of communicating with the first control unit (1) via the interface (7) with the second control unit as a target and the interface (7) as a controller, in which the second control unit (4) generates a setting signal (S9) including the setting information (If1) and inputs the setting signal to the semiconductor device (5) in the first state (First Configuration).

The device module (2a to 2d) according to the first configuration may include a non-volatile memory (10) that stores the setting information (If1), in which the second control unit (4), in the first state, reads the setting information (If1) stored in the non-volatile memory (10) via the communication path (6) to generate the setting signal (S9) (Second Configuration).

The device module (2a to 2d) according to the second configuration may be configured so that the second control unit (4), at least temporarily in the first state, simultaneously performs readout of the setting information (If1) from the non-volatile memory (10) and input of the setting signal (S9) to the semiconductor device (5) (Third Configuration).

The device module (2a to 2d) according to any one of the first to third configurations may be configured so that the second control unit (4) includes an internal memory that stores the setting information (If1), and in the first state, reads the setting information (If1) from the internal memory to generate the setting signal (S9) (Fourth Configuration).

The device module (2a to 2d) according to any one of the first to fourth configurations may be configured so that the setting information (If1) includes a plurality of bits, and the second control unit (4), in the first state, generates the setting signal (S9) including a portion of all the bits and inputs the setting signal to the semiconductor device (5) (Fifth Configuration).

The device module (2a to 2d) according to the fifth configuration may be configured so that the portion is a plurality of the bits configured in byte unit (Sixth Configuration).

The device module (2a to 2d) according to the fifth configuration may be configured so that the semiconductor device (5) is an image sensor configured to capture an image based on the setting information, and functions as a camera module (Sixth Configuration).

A network device (100) disclosed in this specification is configured to include: the device module (2a to 2d) according to any one of the first to seventh configurations; the first control unit (1); and a communication bus (3) electrically connecting the device module (2a to 2d) and the first control unit (1) to establish communication between the device module (2a to 2d) and the first control unit (1) via the interface (7) (Eighth Configuration).

The network device (100) according to the eighth configuration may be configured to include multiple device modules (2a to 2d) (Ninth Configuration).

A vehicle (200) is configured to include the network device (100) according to the eighth or ninth configuration (Tenth Configuration).

What is claimed is:

1. A device module, comprising:
a communication path;
a semiconductor device connected to the communication path and configured to operate based on input setting information;
an interface connected to the communication path and configured to establish communication between a plurality of targets connected to the communication path and a first control unit; and
a second control unit connected to the communication path and configured to operate in a first state of communicating with the semiconductor device with the second control unit as a controller and the semiconductor device as a target, or in a second state of communicating with the first control unit via the interface with the second control unit as a target and the interface as a controller,
wherein the second control unit generates a setting signal comprising the setting information and inputs the setting signal to the semiconductor device in the first state.

2. The device module according to claim 1, comprising a non-volatile memory that stores the setting information,
wherein the second control unit, in the first state, reads the setting information stored in the non-volatile memory via the communication path to generate the setting signal.

3. The device module according to claim 2, wherein the second control unit, at least temporarily in the first state, simultaneously performs readout of the setting information from the non-volatile memory and input of the setting signal to the semiconductor device.

4. The device module according to claim 1, wherein the second control unit comprises an internal memory that stores the setting information, and in the first state, reads the setting information from the internal memory to generate the setting signal.

5. The device module according to claim 1, wherein the setting information comprises a plurality of bits, and
the second control unit, in the first state, generates the setting signal comprising a portion of all the bits and inputs the setting signal to the semiconductor device.

6. The device module according to claim 5, wherein the portion is a plurality of the bits configured in byte unit.

7. The device module according to claim 1, wherein the semiconductor device is an image sensor configured to capture an image based on the setting information, and
functions as a camera module.

8. A network device, comprising:
the device module according to claim 1;
the first control unit; and
a communication bus electrically connecting the device module and the first control unit to establish communication between the device module and the first control unit via the interface.

9. The network device according to claim 8, comprising a plurality of the device modules.

10. A vehicle, comprising the network device according to claim 8.
